(19) United States
(12) Patent Application Publication
(10) Pub. No.: US 2024/0304920 A1
(43) Pub. Date: Sep. 12, 2024

(54) INTRINSICALLY-SAFE BATTERY ASSEMBLY FOR WIRELESS FIELD DEVICES

(71) Applicant: Rosemount Inc., Shakopee, MN (US)

(72) Inventors: Cory M. ROBINSON, Mayer, MN (US); Theodore H. SCHNAARE, New Prague, MN (US); Greg E. GINDELE, Maple Lake, MN (US); Ryan C. TARRAS, Savage, MN (US); James A. JOHNSON, Savage, MN (US)

(21) Appl. No.: 18/180,352

(22) Filed: Mar. 8, 2023

(51) Int. Cl. H01M 50/242; H01M 10/42

(52) U.S. Cl. CPC H01M 50/242; H01M 10/425; H01M 2010/4271; H01M 2010/4278

(57) ABSTRACT

An intrinsically-safe battery assembly for wireless field devices is provided. The intrinsically-safe battery assembly includes a battery and a circuit board mounted relative to the battery. The circuit board is electrically coupled to the battery and has a plurality of electrical contacts for connection to the wireless field device. The circuit board may include current limiting circuitry electrically interposed between the battery and the plurality of electrical contacts to limit maximum current drawn from the battery below a threshold. A polymeric structure is operably engaged with the battery and is configured to protect the circuit board and plurality of electrical contacts from mechanical impact.

### BACKGROUND

The present invention relates generally to industrial process control and monitoring systems. More particularly, the present invention relates to wireless process field devices for use in such systems.

In industrial settings, process control systems are used to monitor and control inventories and operation of industrial and chemical processes, and the like. Typically, the system that performs these functions uses field devices distributed at key locations in the industrial process coupled to control circuitry in a control room by a process control loop. The term “field device” refers to any device that performs a function in a distributed control or process monitoring system, including all devices used in the measurement, control, and monitoring of industrial processes. Usually, such field devices have a field-hardened enclosure so that they can be installed outdoors in relatively rugged environments and be able to withstand climatological extremes of temperature, humidity, vibration, and mechanical shock.

Typically, each field device also includes communication circuitry that is used for communicating with a process controller, or other field devices, or other circuitry, over the process control loop. In some installations, the process control loop is also used to deliver a regulated current and/or voltage to the field device for powering the field device. The process control loop also carries data, either in an analog or digital format.

In some installations, wireless technologies are now used to communicate with field devices. Wireless operation simplifies field device wiring and setup. Wireless installations are currently used in which the field device includes a local power source. However, because of power limitations, the functionality of such wireless field devices may be limited.

Wireless field devices may employ an intrinsically-safe local power source that may be replaceable when the energy of the power source becomes depleted or below a selected threshold. When the battery needs to be replaced, it is desirable that the battery is easily replaceable and intrinsically-safe so that it can be replaced in an explosive environment without the requirement for a hot work permit or removing the wireless transmitter from the explosive environment.

Intrinsic safety is a term that refers to the ability of the field device to operate safely in potentially volatile environments. For example, the environment in which field devices operate can sometimes be so volatile that an errant spark or sufficiently high surface temperature of an electrical component could cause the environment to ignite and generate an explosion. To ensure that such situations do not occur, intrinsic safety specifications have been developed. Compliance with an intrinsic safety requirement helps ensure that even under fault conditions, the circuitry or device itself cannot ignite a volatile environment. One specification for an intrinsic safety requirement is set forth in: APPROVAL STANDARD INTRINISICALLY SAFE APPARATUS AND ASSOCIATED APPARATUS FOR USE IN CLASS I, II AND III, DIVISION 1 HAZARDOUS (CLASSIFIED) LOCATIONS, CLASS 3610, promulgated by Factory Mutual Research October 1988. Adaptations to comply with additional industrial standards such as Canadian Standards Association (CSA) and the European Cenelec standards are also contemplated.

Many wireless field devices are rated for Division 1 and Zone 0 areas. This means that explosive gases are likely to be present and that very strict criteria are applied to the electronic equipment used in these areas. If a battery does not meet certain energy limiting criteria or is not properly protected from damage when dropped, it cannot be brought into a Class 1 or Zone 0 area without obtaining a hot work permit and taking actions to temporality declassify the area. This is a time-consuming and costly process. While there are some commercially available batteries that may meet short circuit temperature rise requirements for Intrinsically-Safe certification, they are susceptible to damage when dropped from as little as 2 to 3 feet because the battery positive terminal is often sealed with a brittle glass to metal seal.

Another challenge for powering wireless field devices is securing the battery. Wireless field devices are often installed in very harsh industrial environments. Since the battery of a wireless field device may be expected to last for 10 years, the long-term reliability of the connection to the battery is very important. Fretting corrosion is a phenomenon that can occur when the mating parts of a connection move very slightly relative to each other. When this happens, protective coatings on the mating interfaces of the connector are disturbed leading to formation of corrosion that eventually causes the contact resistance to increase and the battery can no longer power the field device.

### SUMMARY

An intrinsically-safe battery assembly for wireless field devices is provided. The intrinsically-safe battery assembly includes a battery and a circuit board mounted relative to the battery. The circuit board is electrically coupled to the battery and has a plurality of electrical contacts for connection to the wireless field device. The circuit board may include current limiting circuitry electrically interposed between the battery and the plurality of electrical contacts to limit maximum current drawn from the battery below a threshold. A polymeric structure is operably engaged with the battery and is configured to protect the circuit board and plurality of electrical contacts from mechanical impact.

### BRIEF DESCRIPTION OF THE DRAWINGS

FIG. 1 is a diagrammatic view of a wireless field device with which embodiments described herein are particularly useful.

FIG. 2 is a diagrammatic view of a wireless field device.

FIG. 3 is a diagrammatic view of an intrinsically-safe battery assembly in accordance with an embodiment of the present invention.

FIG. 4 is a diagrammatic view of a battery with which embodiments of the present invention are particularly useful.

FIG. 5 is a diagrammatic view of a printed circuit board for an intrinsically-safe battery assembly for wireless field devices in accordance with an embodiment of the present invention.

FIG. 6 is a diagrammatic view of a portion of an intrinsically-safe battery assembly for wireless field devices in accordance with an embodiment of the present invention.

FIG. 7 is a diagrammatic view of a portion of an intrinsically-safe battery assembly for wireless field devices in accordance with an embodiment of the present invention.

FIG. 8 is a diagrammatic view of a fully assembled intrinsically-safe battery assembly for wireless field devices in accordance with an embodiment of the present invention.

FIG. 9 is a diagrammatic view of a fully assembled intrinsically-safe battery assembly for wireless field devices in accordance with another embodiment of the present invention.

FIG. 10 is a diagrammatic view of a printed circuit board for an intrinsically-safe battery assembly for a wireless field device in accordance with an embodiment of the present invention.

FIG. 11 is a diagrammatic view of a printed circuit board for an intrinsically-safe battery assembly for a wireless field device in accordance with another embodiment of the present invention.

FIG. 12 is a diagrammatic view of an intrinsically-safe battery assembly being coupled to a wireless field device in accordance with an embodiment of the present invention.

### DETAILED DESCRIPTION OF ILLUSTRATIVE EMBODIMENTS

Embodiments described herein generally provide an intrinsically-safe, easily replaceable, single cell, low cost, compact battery assembly for wireless field devices. The battery assembly is suitable for an industrial application and provides a reliable electrical connection that is resistant to vibration, shock, and other environmental stresses. In some embodiments, the battery assembly meets all industry intrinsically-safe requirements allowing it to be removed and replaced in a hazardous location without the need for declassifying the area or obtaining a hot work permit. For example, in some embodiments, the battery assembly may meet all Division 1 and Zone 0 requirements to facilitate such operations in the hazardous environment,

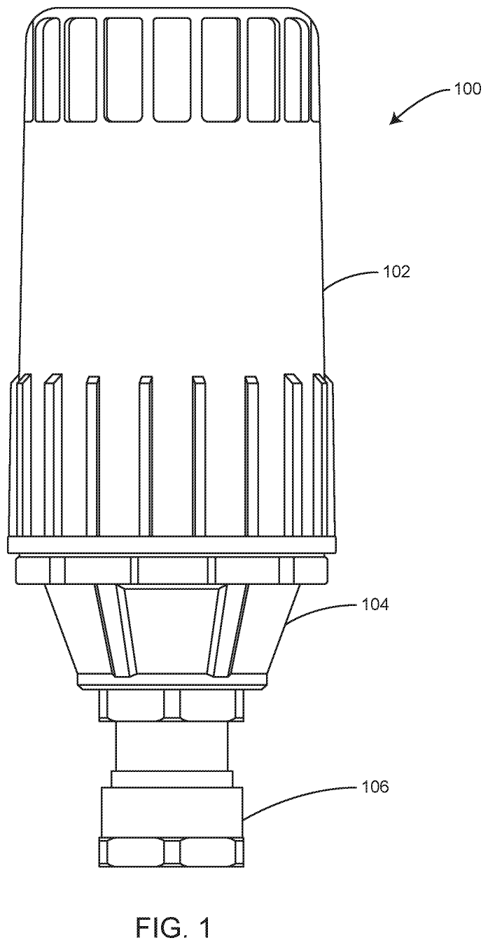

FIG. 1 is a diagrammatic view of a wireless field device with which embodiments described herein are particularly useful. In the illustrated example, field device 100 is a wireless process variable transmitter that measures a process variable, such as temperature, and wirelessly transmits an indication of the process temperature to a remote device or control room (not shown). Field device 100 includes an enclosed, weather-proof compartment 102 that is removably coupled to sensing adapter 104. As used herein, weather-proof means a covered, watertight enclosure. Sensing adapter 104 may take various forms depending on the type of field element used. For example, if the field element is a process variable temperature sensor, sensing adapter may appear as provided in FIG. 1 and be coupled to a process temperature sensor body 106. Sensor body 106, may then be coupled to an industrial process to measure the temperature of a process fluid. As can be appreciated, different types of sensors (e.g., temperature, pressure, acoustic, corrosion, pH, ORP, conductivity, level, gas, etc.) will have different forms for their respective sensor body 106. However, in one embodiment, sensor adapter 104 allows the variety of sensor bodies 106 to be used with the same enclosure 102. Enclosure 102 and/or sensor body 104 can be constructed from any suitable material as long as enclosure 102 is watertight.

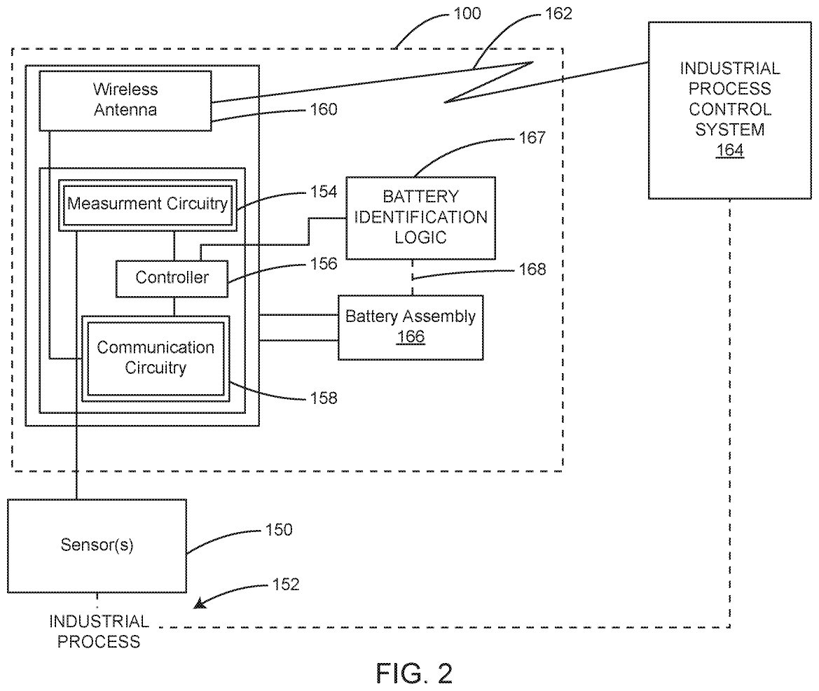

FIG. 2 is a diagrammatic view of a wireless field device 100. As shown in FIG. 2, wireless field device 100 is coupled to one or more sensors 150, which are, in turn, coupled to an industrial process 152. Sensor(s)s 150 may include one or more of any of the process sensors described above. Sensor(s) 150 is coupled to measurement circuitry 154 of wireless transmitter 100. Measurement circuitry 154 receives an electrical output from sensor(s) 150 that represents a process variable that is sensed from an industrial process 152. Measurement circuitry 154 may include suitable analog-to-digital conversion circuitry to transform an analog sensor signal into a digital representation. Additionally, measurement circuitry 154 may include suitable filter circuitry, amplification circuitry, and/or switching circuitry in order to provide compatibility for a variety of different sensor types. Measurement circuitry 154 provides an output representative of the process state to controller 156.

Controller 156 may be any suitable circuitry or combination of circuitry that executes programmatic steps to generate a process variable output based upon signals received from measurement circuitry 154. In one example, controller 156 is a microprocessor. Controller 156 is also coupled to communication circuitry 158 which can receive the process variable output information from controller 156 and provide wireless industry standard process communication signals based thereon. Preferably, communication circuitry 158 allows bidirectional wireless communication utilizing wireless antenna 160. As shown diagrammatically at reference numeral 162, this bidirectional wireless communication generally communicates with the industrial process control system 164. An example of a suitable wireless process communication protocol is set forth in IEC 62591. However, other examples instead of or in addition to IEC 62591 are also contemplated.

As shown in FIG. 2, wireless field device 100 includes an intrinsically-safe battery assembly 166. Battery assembly 166 is electrically coupled to other circuitry of field device 100 to supply operating power to field device 100. Each battery assembly 166 includes a battery (not shown in FIG. 2) and may include intrinsic safety circuitry (not shown in FIG. 2). The battery may be a primary, non-rechargeable battery or it may be a rechargeable battery. In one embodiment, the battery is a lithium ion, non-rechargeable battery. The battery may be in the form of a C-cell battery (length of about 1.9 inches and diameter of about of 1.02 inches) or a D-cell battery (length of about 2.3 inches and diameter of about of 1.3 inches). Other battery types may also be used.

Wireless field device 100 also preferably includes battery identification circuitry 167 that is coupled to, or part of, controller 156. As will be described in greater detail below, embodiments disclosed herein may generally use different battery form factors (e.g., D-cell and C-cell) for powering wireless field device 100. Since different battery form factors generally provide batteries with different energy storage, battery identification logic 167 allows wireless field device 100 to determine the type of battery assembly 166 used. This allows controller 156 to modify operation of wireless field device 100 based on the type of battery detected by battery identification logic 167. Examples of such modification of operation include, without limitation, limiting or inhibiting available features and/or functions, limiting performance, and limiting a measurement interval. An example of limiting or inhibiting available features and or functions can include selectively enabling/disabling a local display of the field device based on available power from the identified type of battery assembly used. Another example includes reducing radio-frequency power of the communication circuitry 158 based on the type of battery assembly used. An example of reducing performance of the wireless field device may include selecting a lower power mode of controller 158 or reducing the set of functions it performs and/or when it performs them. An example of limiting a measurement interval includes changing the measurement interval from 10 times per second to one measurement per minute.

Battery identification logic is coupled, either electrically or mechanically, to battery assembly 166, as indicated by dashed line 168. By virtue of coupling 168, battery identification logic 167 is able to determine a form factor of the battery cell within battery 166. This determination may be done using an electrical aspect of battery 166 or a mechanical aspect of battery 166.

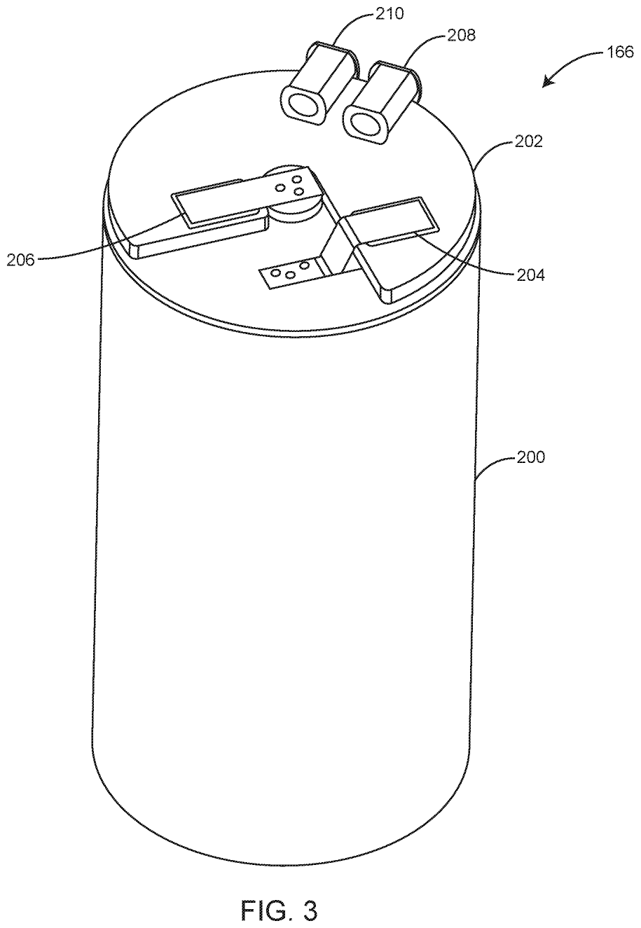

FIG. 3 is a diagrammatic view of an intrinsically-safe battery assembly in accordance with an embodiment of the present invention. Assembly 166 generally includes a battery 200 that is electrically and mechanically coupled to circuit board 202. In the illustrated embodiment, this coupling is done using conductive tabs 204, 206 that are welded (e.g., spot welded) to contacts of battery 200. Conductive tabs 204, 206 may be formed of any suitable metal, but are preferably formed of nickel to facilitate a spot-welding operation. In one embodiment, conductive tabs 204, 206 are soldered to printed circuit board 202. Printed circuit board 202 generally includes a pair of contacts 208, 210 that mate with respective connectors in the wireless field device. In the illustrated example, contacts 208, 210 are surface mount receptacles that are configured to mate with corresponding pins of the wireless field device to provide robust electrical contact.

As set forth above, it is preferred that the intrinsically-safe battery assembly accommodate batteries of different sizes (i.e., C-cell and D-cell). In this regard, the assembly may include offset pins for different battery sizes so that the field device can detect the size and type of battery that is installed. This may allow the field device to modify its operation based on the amount of power available over a selected period of time at a selected level of functionality. Another way to detect the battery size is to include a 3-receptacle/pin connection with a “common” interface with the third connection being tied electrically high or low with a resistor on battery assembly printed circuit board 202 (e.g., high for a D-cell and low for a C-cell). Information about the battery size and type allows field device 100 to limit the availability of certain features or functionality or to impose a limited load profile (e.g., to limit the update interval or to reduce the measurement accuracy) or to completely disable functionality, if desired.

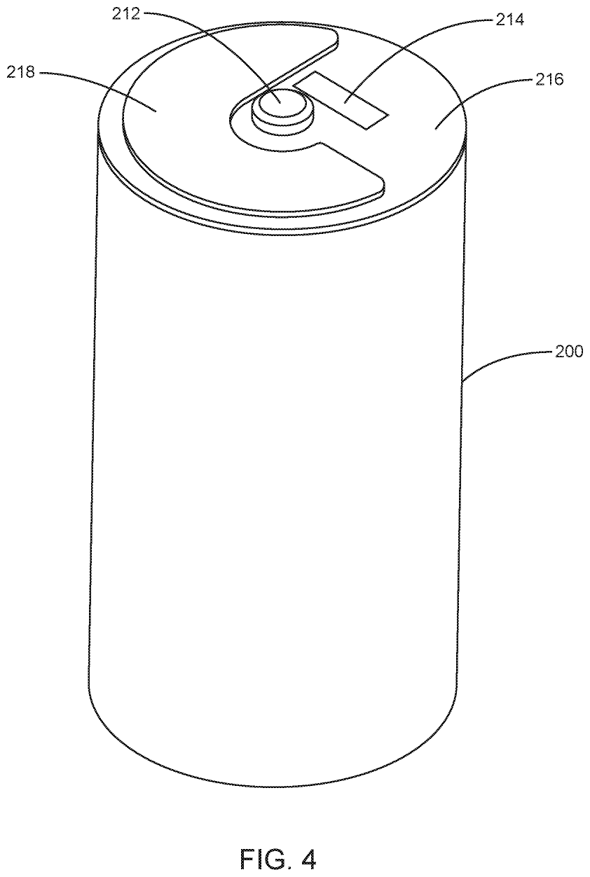

FIG. 4 is a diagrammatic view of a battery with which embodiments of the present invention are particularly useful. As shown in FIG. 4, battery 200 includes a pair of connection points 212, 214 disposed proximate end surface 216. In the illustrated example, connection point 212 is a positive polarity connection point while connection point 214 is a negative polarity connection. FIG. 4. shows a piece of double-sided adhesive, such as tape 218, placed on end surface 216, to mount printed circuit board 202 to end surface 216. However, other methods of mounting or otherwise attaching printed circuit board 202 to battery 200 can be used in accordance with various embodiments described herein.

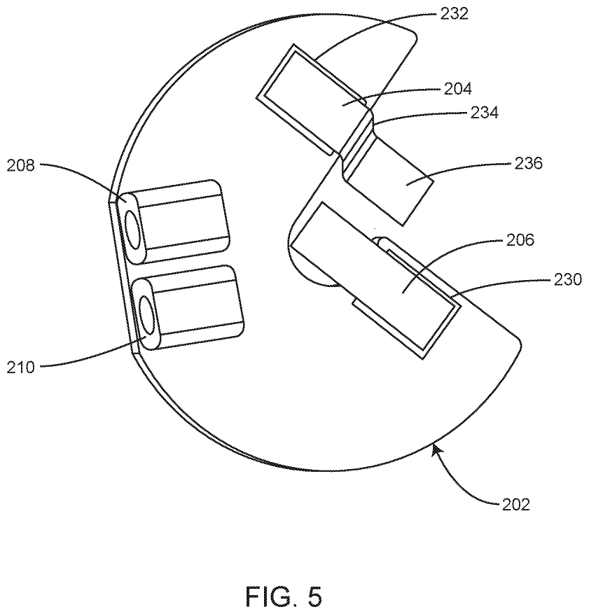

FIG. 5 is a diagrammatic view of a printed circuit board for an intrinsically-safe battery assembly for wireless field devices in accordance with an embodiment of the present invention. As shown, printed circuit board 202 includes conductive tab 206 is soldered to pad 230 of printed circuit board 202. Similarly, conductive tab 204 is soldered to pad 232. Further, as shown in FIG. 5, conductive tab 204 may include a bend 234 such that portion 236 will lay flat upon the corresponding connection point 214 (shown in FIG. 4) of battery 200. This facilitates the connection process (e.g., spot welding).

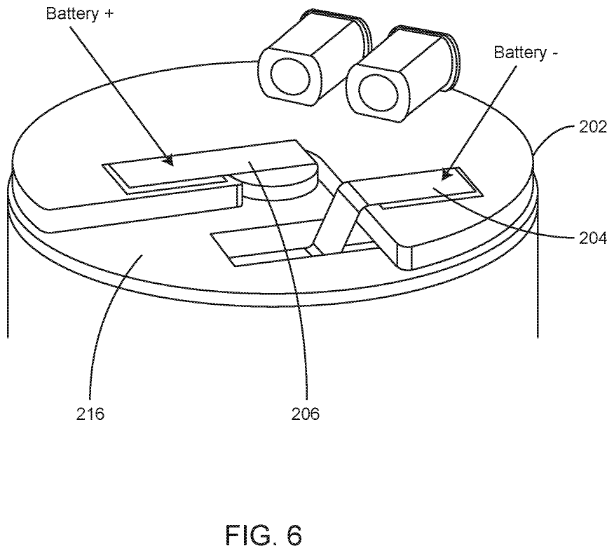

FIG. 6 is a diagrammatic view of a portion of an intrinsically-safe battery assembly for wireless field devices in accordance with an embodiment of the present invention. FIG. 6 illustrates printed circuit board 202 mechanically affixed to surface 216 by adhesive layer 218 (shown in FIG. 4). As can be seen, conductive tab 206 is positioned proximate connection point 212 (shown in FIG. 4) of battery 200 while conductive tab 204 is positioned proximate connection point 214 (shown in FIG. 4) of battery 200.

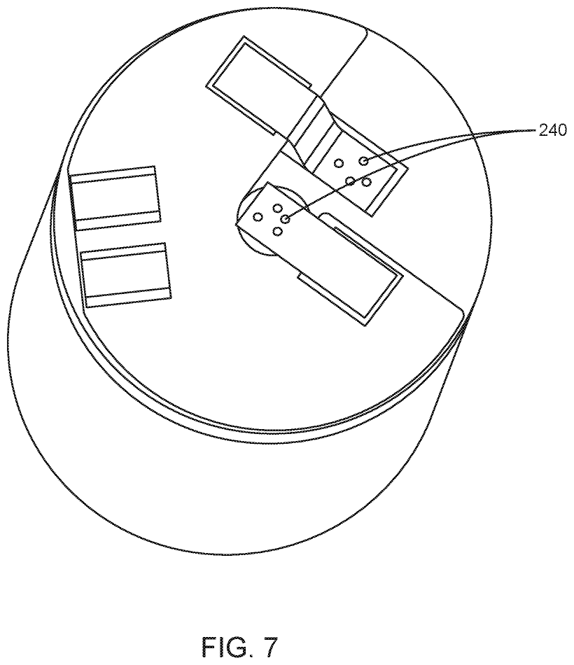

FIG. 7 is a diagrammatic view of a portion of an intrinsically-safe battery assembly for wireless field devices in accordance with an embodiment of the present invention. FIG. 7 is similar to FIG. 6 but shows a number of spot welds 240 that have welded each conductive tab 204, 206 to its respective connection point.

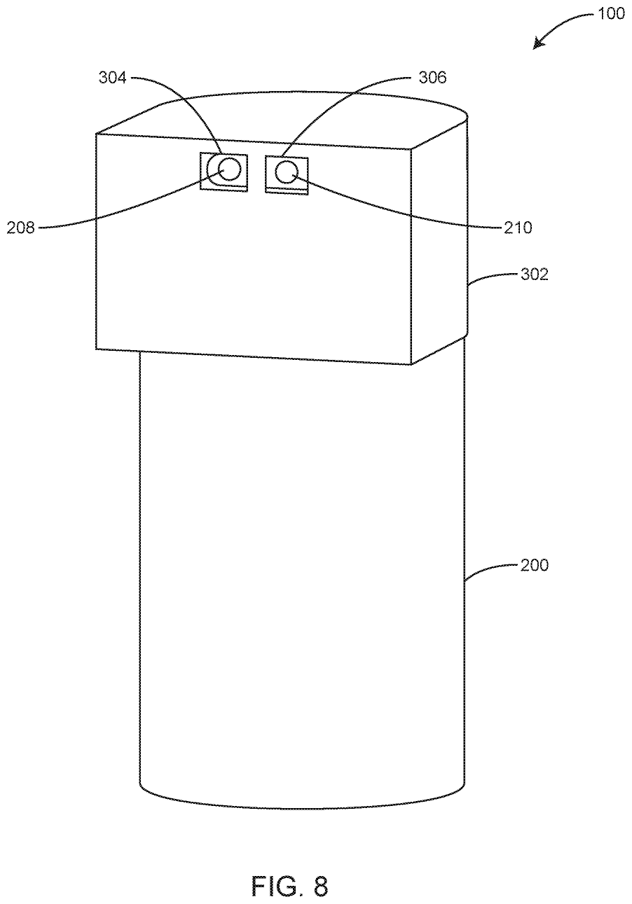

FIG. 8 is a diagrammatic view of a fully assembled intrinsically-safe battery assembly for wireless field devices in accordance with an embodiment of the present invention. Assembly 300 includes a polymeric cap 302 disposed over circuit board 202 with apertures 304, 306 that allow access to contacts 208, 210, respectively. Polymeric cap 302 includes a keying feature, such as its shape that ensures that assembly 300 can only be inserted into the wireless field device in a single rotational orientation. While the keying feature is shown in FIG. 8 as the shape of polymeric cap 302, those skilled in the art will appreciate that other structural aspects of polymeric cap could be modified to provide the keying feature. As shown in FIG. 8, polymeric cap 302 does not extend the full length of battery 200, which thus allows information or other indicia printed on the surface to battery 200 to be readable by the end user. Examples of such information include country of origin and/or warnings to the end user.

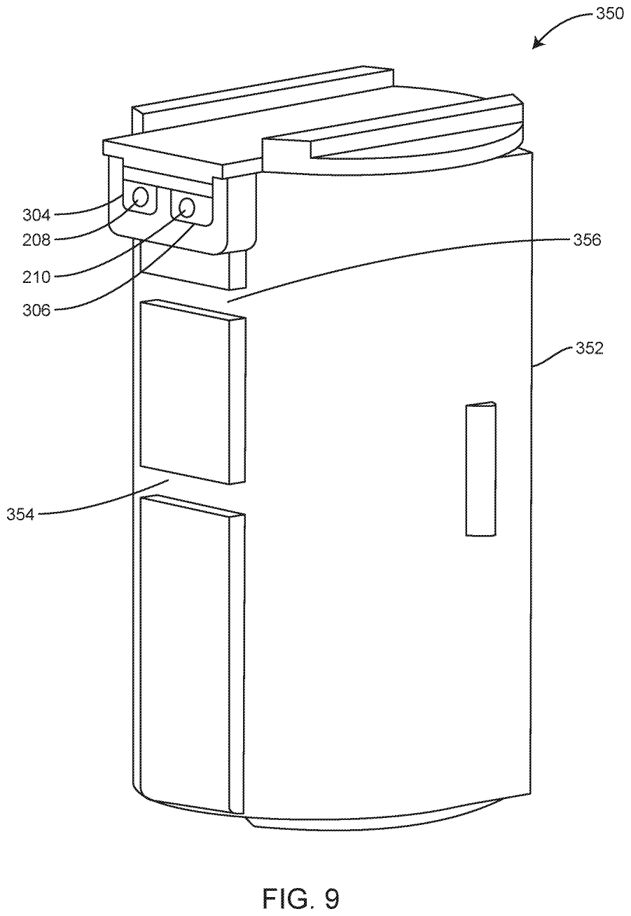

FIG. 9 is a diagrammatic view of a fully assembled intrinsically-safe battery assembly for wireless field devices in accordance with another embodiment of the present invention. Battery assembly 350 is somewhat similar to battery assembly 300 (shown in FIG. 8) and like components are numbered similarly. FIG. 9 shows battery assembly 350 having a pair of apertures 304, 306, that allow access to receptacle 208, 210, respectively. Additionally, battery assembly 350 preferably has apertures 304, 306 positioned at the same height and rotational orientation as in battery assembly 300. Thus, either battery assembly 300 or battery assembly 350 could be used in a given wireless field device. Battery assembly 350 differs from battery assembly 300 in that it includes a full enclosure of the battery. In some examples, a different battery size format can be used, (e.g., C-cell or AA cell) and the physical difference in battery size is accommodated within the enclosure. For example, a c-cell battery may have a spacer around its outer diameter and a spacer proximate an end of the c-cell battery to lift the battery within the enclosure. As shown, battery assembly 350 includes an enclosure that securely mounts the battery therein and then securely fits within the wireless field device in the same way as battery assembly 300, which is configured to employ a D-cell battery.

Battery assembly 350 includes an enclosure 352 that houses the battery as well as a printed circuit board, such as circuit board 202. Enclosure 352 can be constructed from any suitable material. However, it is preferred that enclosure 352 be constructed from a polymer. In some embodiments, the polymer is selected such that enclosure 352 is transparent. This allows the end user to see through the sidewall of enclosure 352 to read country of origin information and/or warnings, graphics or other indicia disposed on the surface of the battery.

As shown in FIGS. 8 and 9, battery assemblies 300 and 350 each include keying features that cooperate with corresponding features of the wireless field device to ensure that the battery assembly can only be installed in a single rotational orientation to make an electrical connection. These keying features help ensure proper electrical connection polarity and also ease installation of the battery assembly into the wireless field device. Additionally, the geometry of the polymeric cap 302 (shown in FIG. 8) and enclosure 352 (shown in FIG. 9) facilitate removal from the wireless field device. Battery assemblies 300, 350 also include one or more features that cooperate with wireless field device to securely retain the battery assembly within the wireless field device. As an example, FIG. 9 illustrates enclosure 352 having a pair of grooves 354, 356 that may be configured to engage tabs within the wireless field device to secure enclosure 352 within the wireless field device. As another example, weather-proof compartment 102 (shown in FIG. 1) may include a removable cover that is configured to engage one or more features of the battery assembly when the cover is secured in place. Additionally, both the polymeric cap 302 of battery assembly 300 (shown in FIG. 8) and the polymeric enclosure 352 of battery assembly 350 (shown in FIG. 9) are examples of a polymeric structure that is configured to protect the circuit board and plurality of electrical contacts from mechanical impact.

In some embodiments, the battery assembly can be provided with a feature that inhibits electrical connection to the wireless field device until the user changes or removes the feature. For example, a non-conductive tab could be positioned proximate apertures 304, 306 to prevent pins from accessing receptacles 208, 210. In another example, a portion of non-conductive tape may be applied over apertures 304, 306, which tape would then be removed by the end user prior to energization of the wireless field device. This allows the battery assembly to be installed within the wireless field device for shipping but in a state where it is not electrically coupled to the wireless field device.

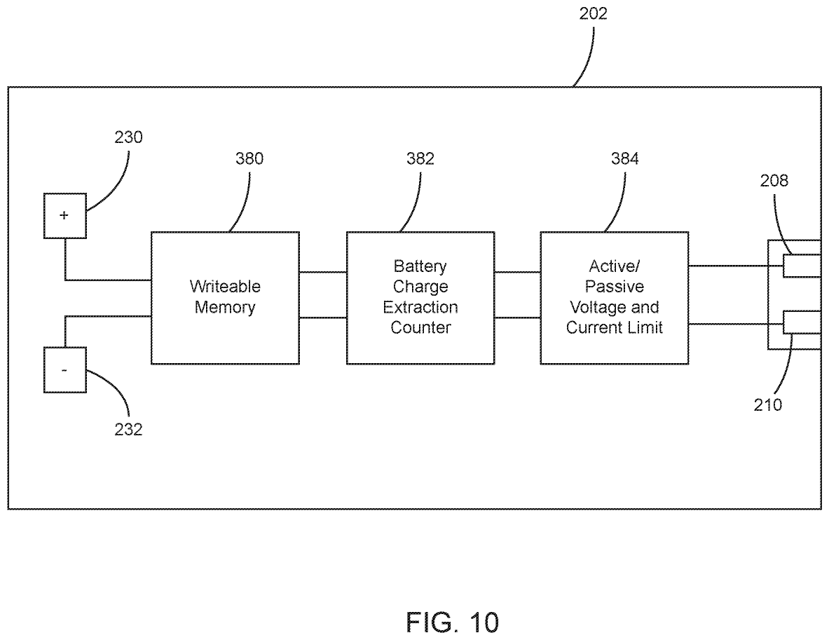

FIG. 10 is a diagrammatic view of printed circuit board 202 with optional modules 380, 382, and 384, for an intrinsically-safe battery assembly for a wireless field device in accordance with an embodiment of the present invention. FIG. 10 shows pads 230, 232 that are configured to be coupled to tabs 204, 206 (shown in FIG. 5). Pads 230, 232 are electrically coupled to optional modules 380, 382, and/or 384 before being coupled to receptacles 208, 210.

Circuit board 202 may include optional module 380. Module 380 may include writeable memory that can be written for factory programming of identification, type, manufacturing date, and/or other relevant information. The writeable memory of module 380 can take any suitable form, such as EPROM or EEPROM. Module 380 may include a microprocessor or microcontroller with writeable NVRAM. Additionally, in some embodiments, writeable memory of module 380 may be embodied on an NFC chip that need not be electrically coupled to pads 230, 232.

Circuit board 202 may include optional module 382, which is a battery charge extraction counter that is configured to allow for battery life monitoring. Module 382 may include any suitable circuitry that monitors energy flow from the battery and/or any other suitable battery parameters or characteristics that are relevant to battery life.

Circuit board 202 may include optional module 384. Module 384 includes active and/or passive voltage and/or current limiting in order to allow the battery assembly to meet an intrinsic safety specification. Active circuit components as used herein are circuit components that provide power into a circuit. In contrast, passive circuits block (e.g., a diode), consume (e.g., a resistor), or store (e.g., a capacitor) energy. The current limiting circuitry of module 384 includes active and/or passive circuitry that is configured to limit maximum current drawn from the battery below a threshold. This current limiting feature facilitates compliance with intrinsic safety specifications, such as that described above.

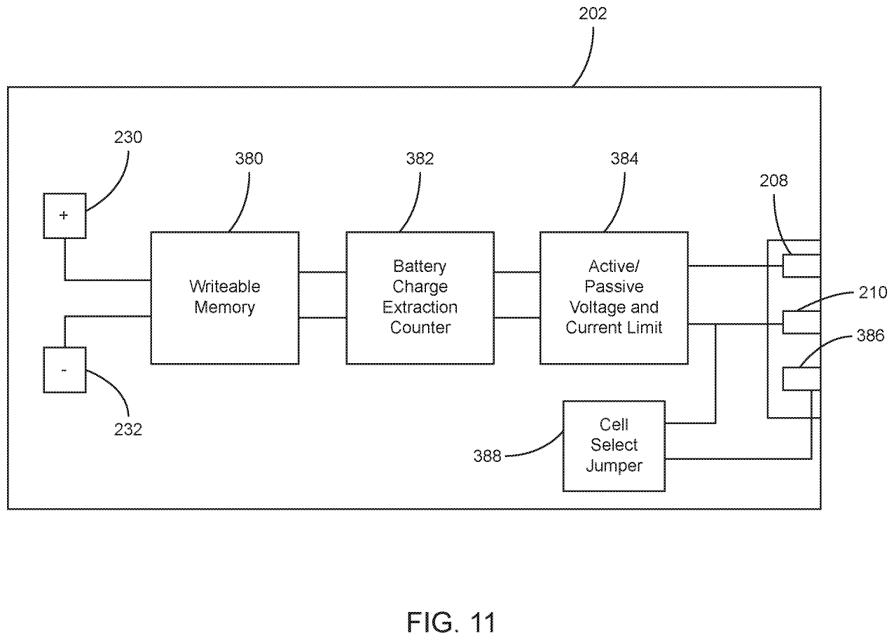

FIG. 11 is a diagrammatic view of printed circuit board 402 for an intrinsically-safe battery assembly for a wireless field device in accordance with an embodiment of the present invention. Printed circuit board 402 is similar to printed circuit board 202 and like components are numbered similarly. Printed circuit board 402 differs from board 202 in that printed circuit board 402 includes an additional receptacle 386 and cell select jumper 388. Additional receptacle 386 is an example of an additional connection between an intrinsically-safe battery assembly and a wireless field device in order to facilitate the provision of cell information. In the illustrated example, cell select jumper 388 can be jumpered (i.e., continuous) or non-jumpered (i.e., open) to indicate whether the battery is a C-cell or a D-cell. Battery identification logic 167 (shown in FIG. 2) can determine whether the cell select jumper is open or continuous by testing continuity between receptacles 210 and 386. While this embodiment is described with respect to a jumper, it is expressly contemplated that other components, such as a switch, could be used instead of a jumper. Further, when more than two battery form factors may be present, it is also contemplated that additional receptacles could be used to convey the battery type information to battery identification logic 117. Further still, while the embodiment shown in FIG. 11 uses continuity, other states, such as high/low can be used with suitable pullup resistors to indicate battery type via one or more receptacles 386. Further still, it is also contemplated that board 402 allows the setting of a battery type that is different than what is actually used for the battery assembly. For example, a D-cell battery could be used with cell select jumper set to indicate a C-cell battery, thereby causing the wireless field device to reduce its power and thus extend the life of the D-cell battery.

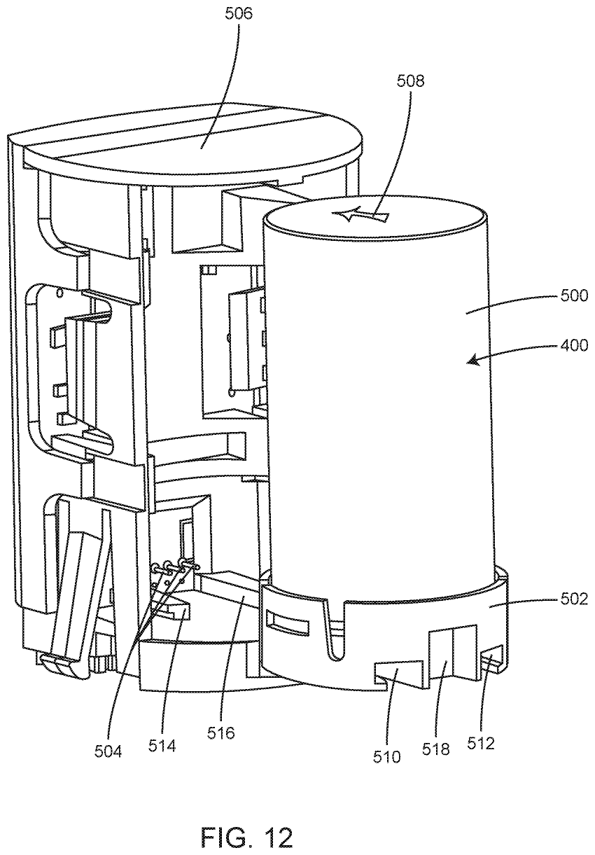

FIG. 12 is a diagrammatic view of an intrinsically-safe battery assembly being coupled to a wireless field device in accordance with an embodiment of the present invention. As shown in FIG. 12, battery assembly 400 bears some similarities to battery assembly 100, and like components are numbered similarly. More specifically, battery assembly 400 includes a battery 500 coupled to a polymeric cap 502 that includes a number of electrical contacts that mate with pins 504 of wireless field device 506 when battery assembly 400 is slid into wireless field device 506 in the direction indicated by arrow 508. As shown in FIG. 12, polymeric cap 502 includes a pair of alignment channels 510, 512 that slide over corresponding features 514, 516 in wireless field device 506 when battery assembly 400 is inserted into wireless field device 506. In this way, the positioning of electrical contacts on battery assembly 400 are carefully controlled such that they automatically couple with pins 504 when the battery assembly is fully inserted. Additionally, channels 510, 512 are preferably mirror images of one another with respect to the center of polymeric cap 502. Thus, battery assembly 400 may also be physically inserted into wireless field device 506 in an orientation that is 180 degrees different than the orientation that automatically creates electrical contact. As shown in FIG. 12, region 518 does not include any electrical connections and thus, when region 518 is facing pins 504, no electrical contact is created. This is a useful storage/shipping orientation for battery assembly 400.

Although the present invention has been described with reference to preferred embodiments, workers skilled in the art will recognize that changes may be made in form and detail without departing from the spirit and scope of the invention.

What is claimed is:

1. An intrinsically-safe battery assembly for wireless field devices, the intrinsically-safe battery assembly comprising:
a battery;
a circuit board mounted relative to the battery, the circuit board being electrically coupled to the battery and having a plurality of electrical contacts for connection to the wireless field device, the circuit board having current limiting circuitry electrically interposed between the battery and the plurality of electrical contacts to limit maximum current drawn from the battery below a threshold; and
a polymeric structure operably engaged with the battery, the polymeric structure being configured to protect the circuit board and plurality of electrical contacts from mechanical impact.

2. The intrinsically-safe battery assembly of claim 1, wherein the battery is a D-cell battery, and the polymeric structure is a polymeric cap.

3. The intrinsically-safe battery assembly of claim 2, wherein the polymeric cap has a shape that is configured to ensure that the intrinsically-safe battery assembly may only be electrically coupled to the wireless field device in a single rotational orientation.

4. The intrinsically-safe battery assembly of claim 1, wherein the circuit board is mounted to an end of the battery.

5. The intrinsically-safe battery assembly of claim 4, wherein the circuit board is mounted to the battery with double-sided tape.

6. The intrinsically-safe battery assembly of claim 2, wherein the polymeric cap is transparent and allows indicia on a sidewall of the battery to be visible when the polymeric cap is engaged on the battery.

7. The intrinsically-safe battery assembly of claim 1, wherein the battery is a C-cell battery, and the polymeric structure is a polymeric enclosure.

8. The intrinsically-safe battery assembly of claim 7, wherein the polymeric enclosure is transparent.

9. The intrinsically-safe battery assembly of claim 1, and further including a feature that distinguishes battery type.

10. The intrinsically-safe battery assembly of claim 9, wherein the feature is an electrical feature.

11. The intrinsically-safe battery assembly of claim 10, wherein the electrical feature includes an additional electrical contact that is configured to couple to the wireless field device.

12. The intrinsically-safe battery assembly of claim 1, and further comprising writeable memory configured to store information related to the intrinsically-safe battery assembly.

13. The intrinsically-safe battery assembly of claim 1, and further comprising a battery charge extraction counter disposed on the printed circuit board and configured to monitor battery life.

14. A wireless field device comprising:
an enclosure;
a controller disposed within the enclosure;
wireless communication circuitry coupled to the controller and configured to communicate with a remote device wirelessly;
battery identification logic configured to determine a battery form factor of an intrinsically-safe battery assembly when the intrinsically-safe battery assembly is coupled to the wireless field device; and
wherein the controller is configured to modify operation of the wireless field device based on a determined battery form factor of the intrinsically-safe battery assembly.

15. The wireless field device of claim 14, wherein the battery identification logic is configured to measure an electrical parameter of the intrinsically-safe battery assembly when the intrinsically-safe battery assembly if coupled to the wireless field device.

16. The wireless field device of claim 14, wherein the battery identification logic is configured to measure a mechanical parameter of the intrinsically-safe battery assembly when the intrinsically-safe battery assembly is coupled to the wireless field device.

17. The wireless field device of claim 14, wherein modification of operation of the field device includes selectively disabling a feature.

18. The wireless field device of claim 14, wherein modification of operation of the field device includes reducing performance.

19. The wireless field device of claim 14, wherein modification of operation includes modifying a measurement interval.

20. The wireless field device of claim 14, and further comprising an intrinsically-safe battery assembly disposed within the weather-proof enclosure, in a different orientation than when electrically connected and electrically isolated from the wireless field device.

21. The wireless field device of claim 20, wherein the orientation of electrical contact and the different orientation are spaced 180 degrees apart.

22. The wireless field device of claim 14, and further comprising:
measurement circuitry configured to measure an electrical characteristic of at least one process sensor; and
wherein the controller is coupled to the measurement circuitry, the controller being configured to receive information indicative of a measured process variable from the measurement circuitry and to calculate a process variable output.

23. An assembly for mounting a battery within a wireless field device, the assembly comprising:
a circuit board configured to be mounted relative to the battery, the circuit board being electrically couplable to the battery and having a plurality of electrical contacts for connection to the wireless field device, the circuit board having current limiting circuitry configured to be electrically interposed between the battery and the plurality of electrical contacts to limit maximum current drawn from the battery below a threshold; and
a polymeric structure configured to operably engage with the battery, the polymeric structure being configured to protect the circuit board and plurality of electrical contacts from mechanical impact.
